(19) United States
(12) Patent Application Publication
(10) Pub. No.: US 2008/0078847 A1
(43) Pub. Date: Apr. 3, 2008

(54) Portable pneumatic washing device

(76) Inventor: Shin-Bing Lai, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, omitted

(21) Appl. No.: 11/540,726

(22) Filed: Oct. 2, 2006

(51) Int. Cl. B05B 9/04; B65D 83/00; A47K 3/26

(52) U.S. Cl. 239/373; 222/402; 4/443

(57) ABSTRACT

Portable pneumatic washing device 10 having a body 1 consists of three axially arrayed pipes 11˜13, a transversal valve pipe 14. Pipe 11 impelled by a push rod 6 to pump air into body 1. Distal ends of pipes 12,13 connected to inlet, outlet orifices of the valve pipe 14 respectively. But a proximal end of the pipe 13 securely connected to a hole 15 at a proximal end of the body 1. A control valve 4 installed outside the sidewall of the body 1 switches on/off the inlet orifice 141 of the valve pipe 14. When the inlet orifice 141 open, a liquid retained in the body 1 flows through pipe 12, valve pipe 14 into a telescopic spray pipe 2 of the pipe 13 to spill liquid from the spray head 3 at a distal end of the spray pipe 2 outside the hole 15.

### FIELD OF THE INVENTION

The present invention relates to a pneumatic washing device, particularly to a portable timely releasing liquid to wash an excretory organ of human kind or a dead space of stool.

### BACKGROUND OF THE INVENTION

Nowadays, an improved living standard is commending whatever sanitary problems encountered by the people suffered from such as hemorrhoids (piles) must be provided with personal solution to the problems. Therefore, kinds of stools with hemorrhoids-free function are already promoted on the market. But, a washing device is fixed inside the stool, which must be equipped with an electric circuit panel and electrified to operate in use. Such a fixed and, of course, electrified washing device is not designed as personal belongings, which could not be applied to one at one's will wherever he goes. In consideration of the problems encountered by the people suffered from hemorrhoids, especially for women, disabled, obesity etc., those skilled in the art have provided portable washing device designed for them to operate by oneself, exclusive use for excrements about infants' excretory organs could be cleaned out by this washing device.

Such as TW M269033 entitled “portable hand operated washing device” to the inventor of the present invention on Jul. 1, 2006, in which, it disclosed a cylinder 1 having a liner 2 filled with water, a spray pipe 3 extended from a bottom of the liner 2, an expanded spring 41 mounted on the liner 2, said spring 41 is drawn by a pulling line 441 to reduce to an almost-flat ring, the reduced spring 41 is locked by a fastener 43, when the user presses down the fastener 43 to release the spring 41, which presses the liner 2 to jet out the liquid by spray pipe 3. Thereby, the excrements can be washed out.

TW M269034 entitled “portable electric washing device” to the inventor of the present invention on Jul. 1, 2006, in which, it disclosed a cylinder 1 filled with liquid having a hermetically sealed motor 2 installed thereunder, a discharging opening of the motor is connected to a flexible pipe 3, in turn, the end of the flexible pipe 3 is connected to a spray pipe 4, a battery chamber 11 situated onto a top portion of the cylinder 1, a conductive line is connected between the battery chamber 11 and the motor 2, a switch 12 switches on/off the power of the motor 2, the user uses the electric washing device to jet out the liquid in the cylinder 1 efficiently.

According to the aforesaid TW M269033, a portable hand operated washing device must be equipped with a liner 2 inside the cylinder 1, whenever a water supply is to re-fill therein, a cover 4 on top of the cylinder 1 should be open to fill the water into the liner 2. A number of steps are requested to fulfill the demands of the washing device to release a spring 41 press the liner to jet out water, not only the flow rate of the jet is out of control, but also the washing duration is unpredictable. In other words, each jet is to outpour the water retained in the cylinder 1 until the water is exhausted. Furthermore, a middle portion of the spray pipe 3 is a telescopic soft hose, but the middle portion must be bent due to the space in the cylinder is shorter than the middle portion of spray pipe 3. Where the middle portion is bent the fluid may be blocked, after a longer while, the bent hose may be damaged that make a crack visible to leak out the fluid from rough usage.

According to the aforesaid TW M269034, a portable electric washing device is powered by a set of batteries to start the hermetically sealed motor 2, once the electric power is used up, the batteries must be replaced. Although a battery chamber 11 is situated on the top portion inside the cylinder, but moisture of leaking out water may result in short circuit in between. Furthermore, the hermetically sealed motor 2, when breaking down, may lose the motive force, then the water is no longer jetted out. It may cause inconvenience to the people suffered from such as hemorrhoids as they depart for anywhere away from their homes.

### SUMMARY OF THE INVENTION

Accordingly, the present invention is aimed to provide a timely hand-operated pneumatic washing device; either operating a handle, the washing duration is under control by a user at will, or by rotating the spray pipe, the flow rate of the portable pneumatic washing device is adjusted in compliance to the user's requirements.

Point against the problems as discussed above, the means whereby the present invention attains the goal is realized as claim 1 claimed: a portable pneumatic washing device 10 comprising: a body 1 being a container for filling with fluid having a first, second, and third pipes 11˜13 installed therein axially, and a valve pipe 14 installed therein transversally; said valve pipe 14 is installed to a distal portion inside the body 1 transversally, said first pipe 11 is an air pump for pumping air from outside into the body 1, said second pipe 12 is an inlet pipe having an inlet orifice 121 formed at a proximal end of the second pipe 12, in addition to an inlet orifice 141 of the valve pipe 14 communicates with a distal end of the second pipe 12; a third pipe 13 is an outlet hose having a distal end communicates with an outlet 142 of the valve pipe 14, a proximal end of the third pipe 13 communicates with a hole 15 of a base plate of the body 1;

a spray pipe 2 having a proximal end connected to the hole 15 of the base plate at the proximal end of the body 1, a distal end of the spray pipe 2 connected to a long pipe of the spray head 3;

a spray head 3 adjusts a symmetrical jet flow rate into a jet stream; and

a control valve 4 installed to the distal portion of said body 1, a handle 41 outside the body 1 switches on/off the inlet orifice 141 inside said valve pipe 14.

### BRIEF DESCRIPTION OF THE DRAWINGS

FIG. 1: shows a perspective view of a pneumatic washing device of the first embodiment of the present invention;

FIG. 2: shows a cross sectional view indicated by A-A in FIG. 1;

FIG. 3: shows a diagrammatic view of the action of FIG. 1;

FIG. 4: shows a cross sectional view of the inlet orifice opened on the valve pipe by a control valve in FIG. 1;

FIG. 5: shows a perspective view of the pneumatic washing device of the second embodiment of the present invention;

FIG. 5a: shows a cross sectional view of the spray pipe extended out as a single pipe;

FIG. 5b: shows a cross sectional view of the spray pipe extended as a ‘double containment pipe’;

FIG. 6: shows an assembled view of the pneumatic washing device in FIG. 5;

FIG. 7: shows a diagrammatic view of a pneumatic washing device applied to a stool on which the user is squatting on the ground;

FIG. 8: shows a diagrammatic view of a pneumatic washing device applied to a stool on which the user generally is sitting on the stool; and

FIG. 9: shows a diagrammatic view of a pneumatic washing device applied to clean excrements about excretory organ of an infant.

### DETAILED DESCRIPTION OF THE PREFERRED EMBODIMENTS

The description is described according to the appended drawings hereinafter.

### First Embodiment

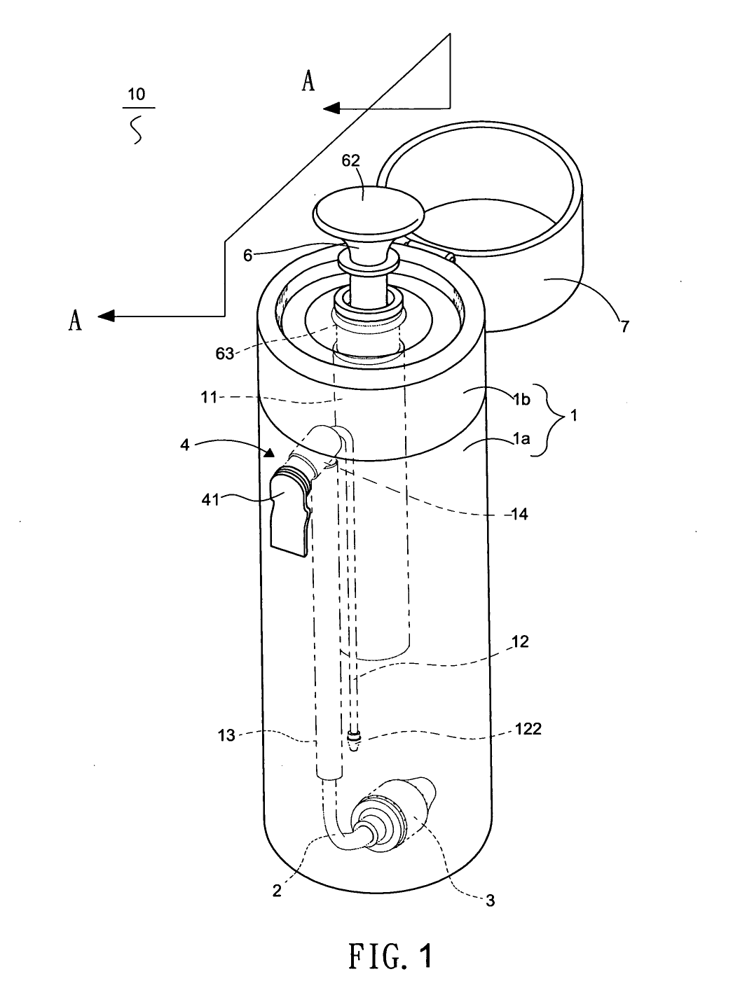

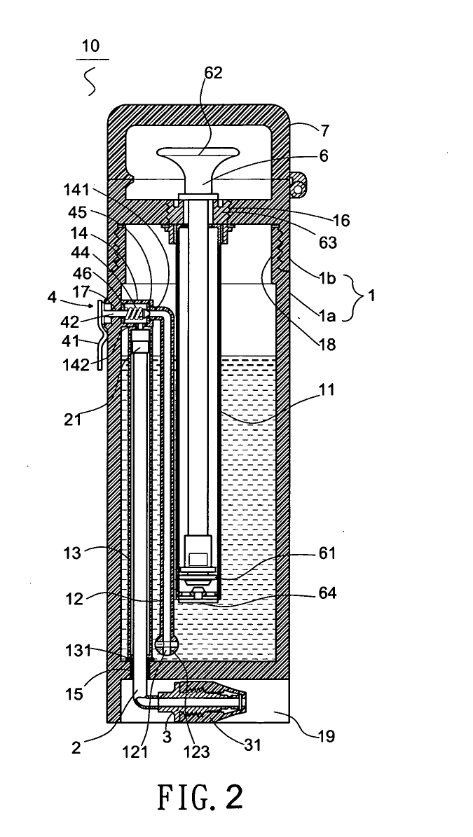

Refer to FIGS. 1 and 2, a perspective view of the pneumatic washing device of the first embodiment of the present invention, a cross sectional view indicated by A-A in FIG. 1 are illustrated. A pneumatic washing device 10 includes a body 1, a spray pipe 2, a spray head 3, a control valve 4, a push rod 6 and a cover 7. Said body 1 is a container with internal circular diameter filled with liquid, the body 1 can be integrally formed by injection modeling. Or the body 1 is assembled by a base cylinder 1a and a screw top cover 1b threaded to an opening at a distal end of the base cylinder 1a. When water supply is about to re-fill, only the screw top cover 1b is screwed open to fill the liquid within. Next, a water supply orifice (not shown) can be formed through the cover 1b or a sidewall with a water supply cover (not shown) threaded to the water supply orifice, where the water supply cover is screwed open, the liquid can be re-filled within the body 1.

Inside said body 1, a first, second, and third pipes 1113 are axially arrayed in parallel to the longitudinal axis of the body 1, and a valve pipe 14 is transversally installed inside the body 1. Said valve pipe 14 is transversally placed into the upper portion inside the body 1. Said first pipe 11 is an air pump for pumping air from outside into the body 1. Said second pipe 12 is an inlet pipe, an inlet orifice 121 formed at a proximal end thereof; a distal end of the second pipe 12 communicates with an inlet orifice 141 of the valve pipe 14. Said third pipe 13 is an outlet pipe, a distal end of the third pipe 13 communicates with an outlet orifice 142 of the valve pipe 14, and a proximal end of the third pipe 13 communicates with a hole 15 formed through a base plate (or a base plate of the base cylinder of the body 1) at a proximal end of the body 1.

Said spray pipe 2 is a long pipe, a proximal end of the spray pipe 2 is connected to the hole 15 of the base plate of the body 1, a distal end of the spray pipe 2 is connected to a spray head 3. In use, when the spray pipe 2 is fixed below the hole 15, the spray pipe 2 is an unextended pipe. When the spray pipe 2 is non-fixed, but movable properly fit through the hole 15, in other words, the spray pipe 2 is substantially telescopic in manner; therefore, the spray pipe 2 can pass through the hole 15 into the third pipe 13. Said spray head 3 is a jet can adjust the flow rate of jet stream. Said control valve 4 is installed to a distal portion of the body 1, a handle 41 outside the body 1 switches on/off an inlet orifice 141 inside said valve pipe 14. Said push rod 6 installed inside the first pipe 11 can be impelled for transmitting reciprocating motion within the first pipe 11. Said cover 7 is mounted on the screw top cover 1b, and cover 7 can be raised/lowered as desired.

Said first pipe 11 is installed to a center of the body 1 with internal circular diameter, a distal end of the first pipe 11 is fixed inside an orifice 16 formed through a distal end of the body 1 by means of a sleeve 63. A push rod 6 is received inside the first pipe 11. A proximal end of said push rod 6 is a piston 61 fit through the first pipe 11. A distal end of said push rod 6 is a handle 62 located outside the first pipe 11 and the body 1. In addition, a proximal end of the first pipe 11 is equipped with a one-way valve 64 to expel air out of the first pipe 11.

Said second pipe 12 is an inlet pipe, an inlet orifice 121 formed at the proximal end of the second pipe 12 can be equipped with a sponge like filter 122 (as shown in FIG. 1) to filter through impurities by the action of percolating liquid. In addition, the second pipe 12 can be a soft hose in application; an inlet orifice 121 of the soft hose further can be coupled together with a sizable ball 123 (as shown in FIG. 2) made of metal or plastics. Because an inlet orifice is formed on the sizable ball 123, when the body 1 is placed inversely or inclined to one side, the sizable ball 123 will move to where is lower than others by gravity. Even the inlet orifice of the sizable ball can be used to absorb liquid. In compliance with the inclination or inversion, the proximal end of the second pipe 12 (soft hose) is also moved to where the sizable ball is. As a result, no matter the body 1 is placed at what kind of a selected angle, the liquid flows into the second pipe 12. Since a sizable ball coupled to a soft hose is a well-known prior art, which is already applied to a feeding bottle and a fire extinguisher, the principle and function of them will not be introduced in detail.

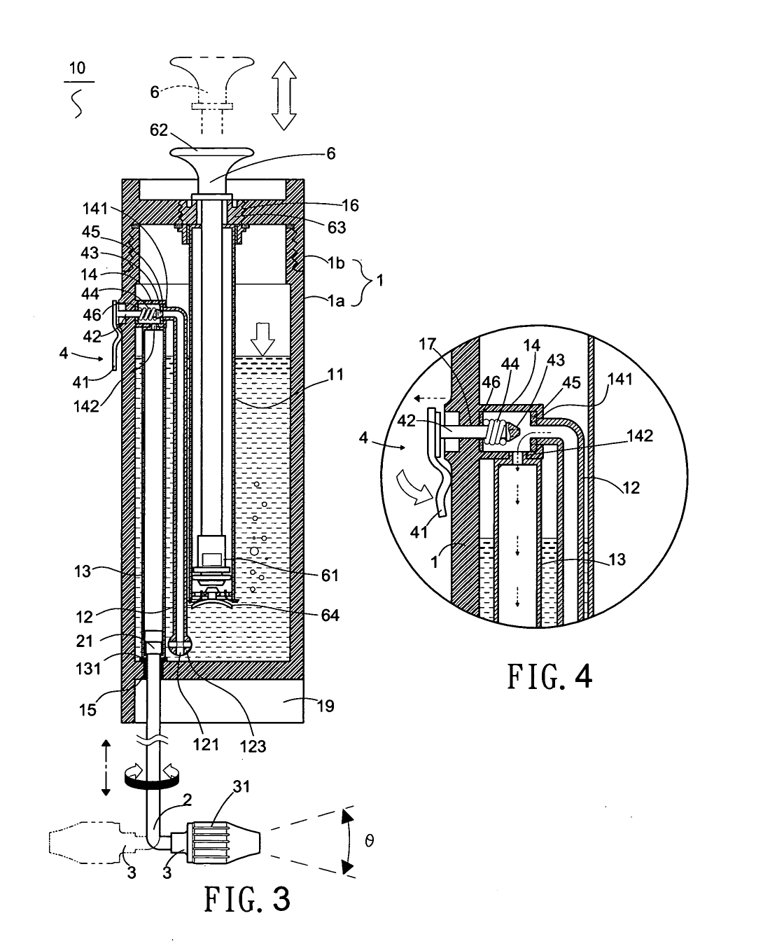

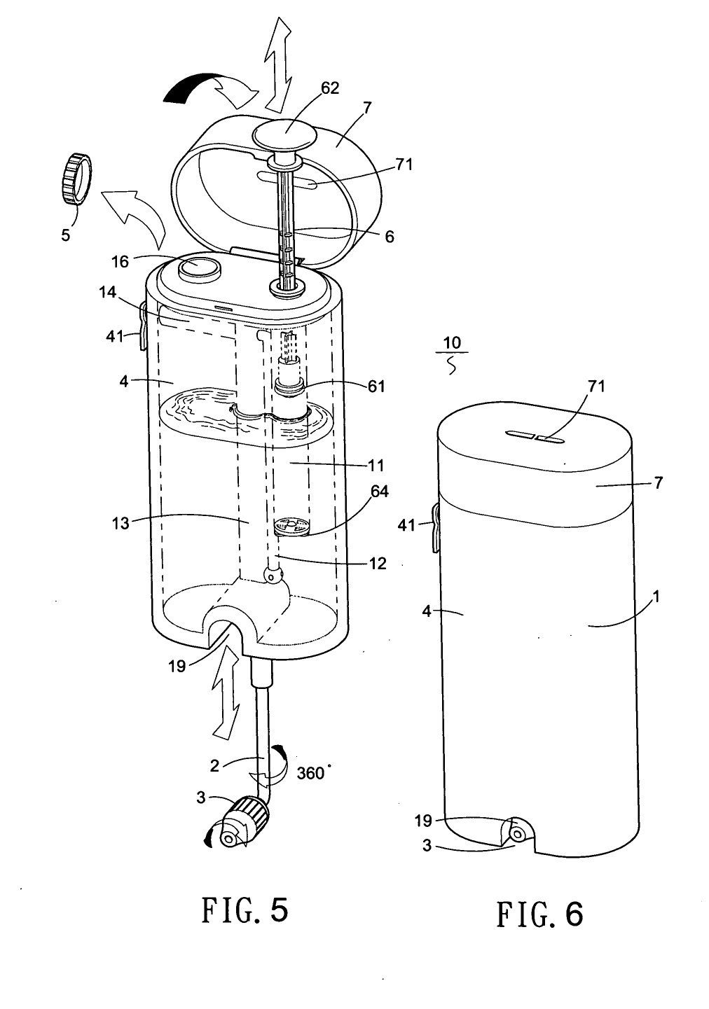

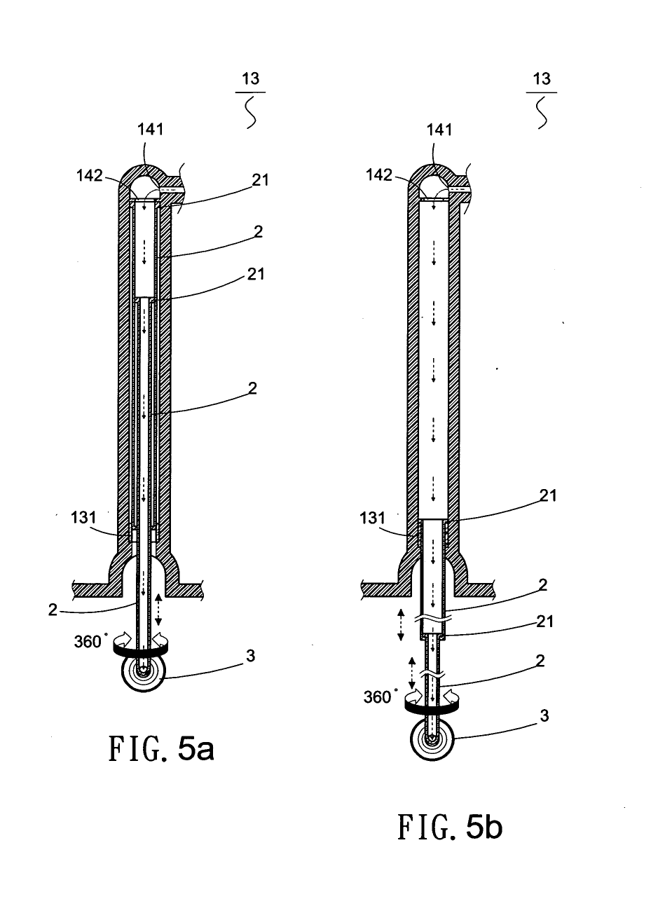

Said third pipe 13 is a hollowed outlet pipe, a proximal end of the third pipe 13 is closely connected to the hole 15 of the base plate of the body 1. To attain a water proof effect, a water proof rubber sleeve 131 is installed inside the hole 15. Thereby the spray pipe 2 can fit through the hole 15. As shown in FIG. 3, the spray pipe 2 is telescopically extended into the third pipe 13. Because a stopper ring 21 is installed to the inlet orifice of the spray pipe 2, a diameter of the stopper ring 21 must be larger than the spray pipe 2. in other words, the stopper ring 21 substantially fits around the distal end of spray pipe 2, even the spray pipe is a ‘double containment pipe’, for example, a spray pipe 2 consists of a secondary pipe extended from the primary pipe, the stopper ring 21 will resist against the proximal end of the third pipe 13 to extend the spray pipe 2 to the utmost length. Therefore, whenever the spray pipe 2 is pulled outward from the hole 15, the stopper ring is obstructed by the water proof rubber sleeve 131. Thereby, the spray pipe 2 will not be pulled outward anymore. Next, as shown in FIG. 2, the spray pipe 2 is a single pipe, which can be extended as FIG. 5a depicted. But the spray pipe 2 can also be a ‘double containment pipe’ (not shown) drawn to its utmost length equal to an inner pipe plus an outer pipe totally extended out of the third pipe as FIG. 5b depicted. They are combined to form a plurality of pipes telescopically engageable with one another, such pipes are a well-known prior arts, there will be no more discussion in detail about them.

Furthermore, said control valve 4 is substantially composed of a handle 41 installed outside the body 1, an axle 42 connected to the handle 41 is first passed through a hole 17 on the sidewall and then being lead into said valve pipe 14. Rather, a cork 43 connected to the axle 42 switches on/off an orifice 141 of said valve pipe 14. A spring 44 accommodates the axle 42 threaded through, a distal end of the spring 44 props up said hole 17, and a proximal end of the spring 44 props up the cork 43. Next, the inlet orifice 141 of said valve pipe 14 is equipped with a water proof rubber ring 45, the hole 17 formed on the sidewall of the body 1 is equipped with a water proof rubber ring 46 as well. Both of the water proof rubber rings 45, 46 protect the valve pipe 14 from leaking out liquid.

As discussed above, a rotation range of the spray pipe 2 can be rotated at full 360° (degrees), where the spray pipe 2 is designed with a telescopic and angle adjusted capacity, especially adjacent to the proximal end of the spray pipe is bent at a right angle (90 degrees), and the spray head 3 is connected to the proximal end of the spray pipe 2. The spray head 3 is equipped with a rotation cover 31, which can be rotated to adjust the flow rate of the liquid at a degree. Said spray head 3 is a well-known structure and technique, which is applied to the flower water spray, fire extinguisher etc. there has no more discussion in detail about it.

Furthermore, a proximal end of the body 1 has a trough 19 concaved downward for receiving the spray head 3 therein. The proximal end of the body 1 can be leveled off for placing on the surface of objects stably and horizontally. And a thermo insulation layer, such as Styrofoam, is embedded inside the sidewall to facilitate the user spilling warm liquid in winter.

Refer to FIG. 3, a diagrammatic view of the pneumatic washing device in use is illustrated. In which, when the cover 7 is screwed open, the user only needs to impel the pull rod 6 and piston 61 for reciprocating motion to expel the air from the first pipe 11 into the body 1. A boost pressure above atmospheric pressure is therefore increased to the body 1 than the air pump i.e. first pipe 11. While a one-way valve installed at the proximal end of the first pipe 11 is only applied to expel the air from outside into the body 1, the liquid will not flow into the first pipe 11. After the body 1 is passed through an air-pump process, a boost pressure is ready for spilling jet stream or current out of the body 1.

Refer to FIG. 4, a cross sectional view of a control valve opening an inlet orifice of the valve pipe is illustrated. When pressing down the handle 41, the cork 43 separated from the inlet orifice 141 of the valve pipe 14 results in the liquid retained in the second pipe 12 flows into the valve pipe 14 via an outlet orifice 142 into the third pipe 13, finally the spray pipe 2 inside the third pipe 13 is filled with liquid, which is spilled out from the spray head 3 at the distal end of the spray pipe 2.

### Second Embodiment

Refer to FIG. 5, a perspective view of the pneumatic washing device of the second embodiment of the present invention is illustrated. Refer to FIG. 6, an assembled view of the pneumatic washing device of FIG. 5 is illustrated.

In FIGS. 5, 6, the body 1 of the pneumatic washing device having an internal oval diameter, where the first pipe 11 and push rod 6 are located at one side of the body 1, and a water supply orifice 16 as well as a cover 5 are located at the other side of the body 1.

Furthermore, the body 1 of the second embodiment is not composed of a base cylinder 1a and a cover 1b as described in the first embodiment. But a water supply orifice 16 and a water supply cover 5 are located at the distal end of the body 1. Users only need to take off the water supply cover 5, liquid can be filled into the body 1. Besides, a slot 71 formed through the cover 7 is suitable for a cord (not shown) passing therethrough to facilitate bringing the washing device out or hanging it on the wall.

Because the second embodiment in practice has the same configuration and mechanism as the first embodiment, there is no more discussion in detail about that.

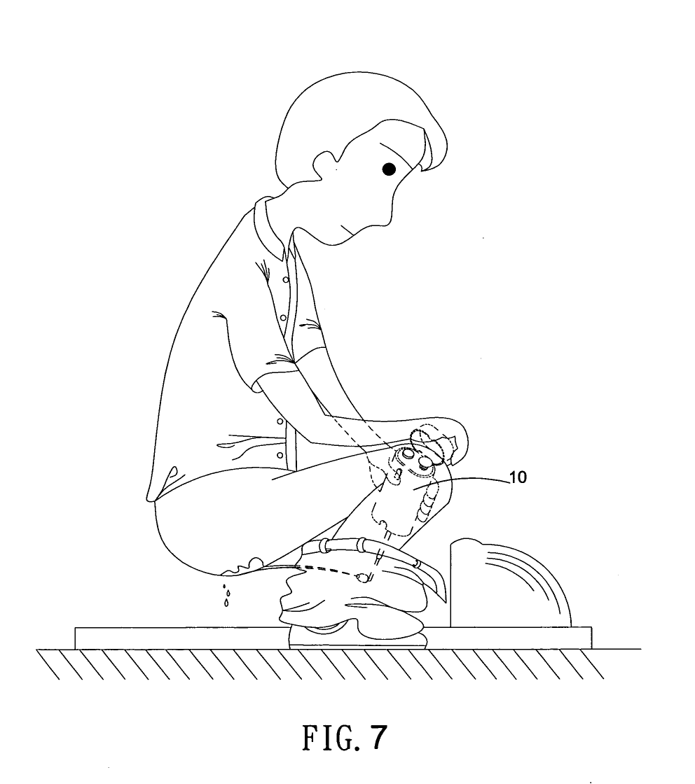

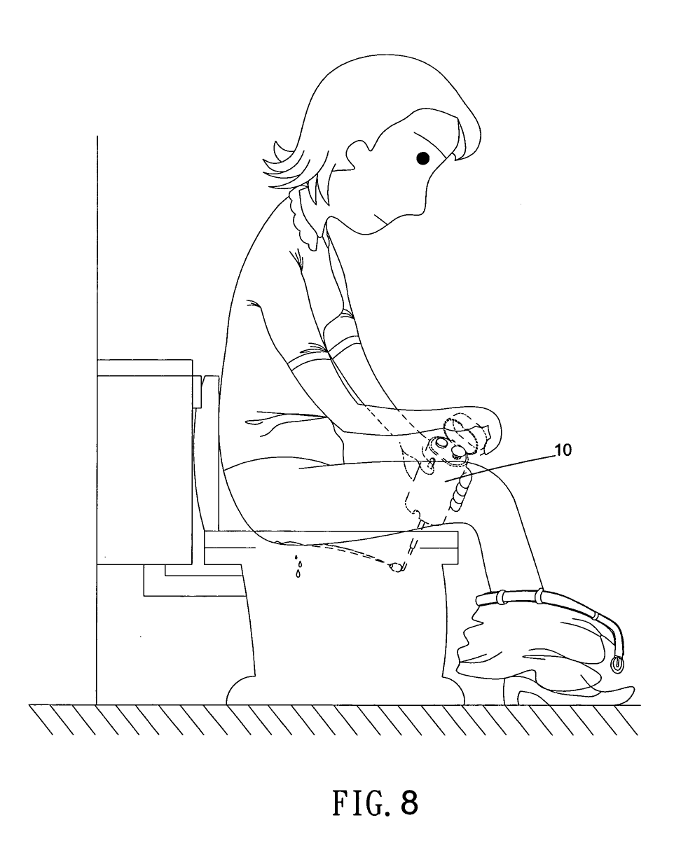

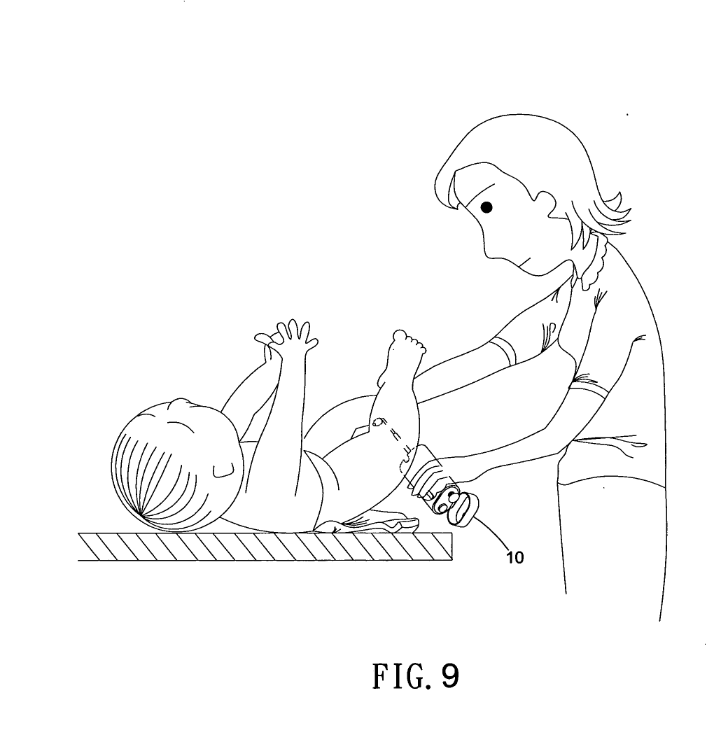

FIGS. 7˜9 are diagrammatic views of the pneumatic washing device in practice are illustrated. Where the FIGS. 7 and 8 show the pneumatic washing device 10 is adapted to the users squatting on the ground or sitting on a stool. When the stool is not equipped with a built-in washing device, the user can take advantage from a portable pneumatic washing device 10 operated in personal use. In FIG. 9, mother-child attachment originates from such as cleaning out the excrements about an infant's excretory organ by means of the pneumatic washing device. Especially, to avoid from tarnishing the surrounding environment, washing device is applied to clean such as a rash affected part about an infant's butt before changing a diaper, the fecal residue mixed with washing liquid can be absorbed by the diaper placed below the infant butt. Therefore, only the diaper must be disposed of without further contaminating the surrounding environment.

Besides, the pneumatic washing device 10 is further provided with a workload for cleaning out the stool cover, dead space of the stool, it is not restricted to cleaning out excrements about infant's rash affected part.

### Feature of the Present Invention for Comparison to the Prior Arts

Portable pneumatic washing device 10 is not necessitated the use of an electric power, but an increased above atmospheric pressure is pumped by hand to increase to a boost pressure in the body 1. Once a user presses down a handle 41, the liquid retained inside the body 1 is induced by the boost pressure to flow through the second pipe 12 and valve pipe 14 into the spray pipe 2 inside the third pipe 13 rapidly. Then the current is spilled out from the spray head 3 at the distal end of the spray pipe 2. Thereby, the excrements remained about the excretory organs or a dead space of an object can be cleaned out. Because the user can operate the handle 41 to switch on/off the current, the liquid retained inside the body 1 is, therefore, economical to jet out the required liquid to the point of what do you use more is consequent on what do you save more on the spot.

Spray head 3 is provided with a flow rate adjustment thereon, see what is the required flow rate.

Spray pipe 2 can be telescopic and movable properly within a full rotation range of 360° (degrees), thereby, the user can select a suitable length and angle in application of the spray pipe 2.

A thermo-insulation layer is embedded inside the sidewall, where liquid temperature in the body 1 maintained for a longer duration benefits the usage in winter or lower temperature.

A trough 18 is concaved downward from the proximal end of the body 1, where the spray head 3 can be received within, moreover, the proximal end of the body 1 can be leveled off suitable for positioning on anywhere stably.

What is claimed is:

1. A portable pneumatic washing device (10) comprising: a body (1) being a container for filling with fluid having a first, second, and third pipes (11˜13) installed therein axially, and a valve pipe (14) installed therein transversally; said valve pipe (14) is installed to a distal portion inside the body (1) transversally, said first pipe (11) is an air pump for pumping air from outside into the body (1), said second pipe (12) is an inlet pipe having an inlet orifice (121) formed at a proximal end thereof; an inlet orifice (141) of the valve pipe (14) communicates with a distal end of the second pipe (12), a third pipe (13) is an outlet pipe having a distal end communicates with an outlet orifice (142) of the valve pipe (14), a proximal end of the third pipe (13) communicates with a hole (15) formed through a base plate at a proximal end of the body (1);
a spray pipe (2) telescopically fit through a hole (15) of a base plate at a proximal end of the body (1), a distal end of the spray pipe (2) connected to a spray head (3);
the spray head (3) adjusts a symmetrical jet flow rate into a jet stream; and
a control valve (4) installed to the distal portion of said body (1), a handle (41) outside the body (1) switches on/off the inlet orifice (141) inside said valve pipe (14).

2. A portable pneumatic washing device (10) according to claim 1, wherein a distal end of the first pipe (11) fixed inside a distal orifice (16) of the body (1) by a sleeve (63), a push rod (6) received within the first pipe (11), a proximal end of the push rod (6) is a piston (61) fit through the first pipe (11), a distal end of the push rod (6) is a handle (62) located outside the first pipe (1) and the body (1), a one-way valve (64) installed at the proximal end of the first pipe (11) to expel air.

3. A portable pneumatic washing device (10) according to claim 1 wherein a control valve (4) consists of a handle (41) installed outside the body (1), an axle (42) connected to the handle (41) passes through a hole (17) on a sidewall of the body (1) fit in the valve pipe (14); a cork (43) connected to the axle (42) switches on/off the inlet orifice (141) of the valve pipe (14), and a spring (44) accommodated the axle (42) threading through, a distal end of the spring (44) props up said hole (17), a proximal end of the spring (44) props up the cork (43).

4. A portable pneumatic washing device (10) according to claim 3 wherein the inlet orifice (141) of the valve pipe (14) and the hole (17) on the sidewall of the body (1) are equipped with rubber rings (45, 46) respectively.

5. A portable pneumatic washing device (10) according to claim 1 wherein a cover (7) installed at a distal end of the body (1) covered up the push rod (6) and inlet orifice cover (5) can be raised/lowered as desired.

6. A portable pneumatic washing device (10) according to claim 1 wherein the proximal end of the body (1) is formed with a trough (19) concaved downward for receiving the spray head (3).

7. A portable pneumatic washing device (10) according to claim 1 wherein a filter (122) installed to the inlet orifice of a proximal end of the second pipe (12) to filter through the impurity by the action of a percolating liquid.

8. A portable pneumatic washing device (10) wherein the second pipe (12) is a soft hose, a sizable ball (123) with an orifice coupled to the inlet orifice (121) of the soft hose (12), the sizable ball (123) is made of metal or plastics.

9. A portable pneumatic washing device (10) according to claim 1 wherein the spray pipe (2) is fixed below the hole (15) of the base plate at the proximal end of the body (1).

10. A portable pneumatic washing device (10) according to claim 1 wherein the spray pipe (2) passed through the hole (15) of the base plate at the proximal end of the body (1), the spray pipe (2) is telescopic within the third pipe (13).

11. A portable pneumatic washing device 10 according to claim 1 wherein the spray pipe (2) consists of a primary pipe and a secondary pipe, the secondary pipe is telescopic within the primary pipe, in turn, the primary pipe is telescopic within the third pipe (13) to form a plurality of pipes telescopically engageable with one another.

12. A portable pneumatic washing device (10) according to claim 1 wherein a thermo-insulation layer embedded inside a sidewall of the body (1).

13. A portable pneumatic washing device (10) according to claim 1 wherein the spray pipe (2) has a rotation range 360° (degrees), adjacent to a proximal end of the pipe (2) bent at a right angle (90°).

14. A portable pneumatic washing device (10) according to claim 1 wherein the body (1) is shaped as a pipe with internal circular diameter, said first pipe (11) and push rod (6) are installed at a center of the body (1) with internal circular diameter.

15. A portable pneumatic washing device (10) according to claim 14 wherein the body (1) consists of a base cylinder (1a) and a screw top cover (1b) threaded to an opening (18) of the base cylinder (1a).

16. A portable pneumatic washing device (10) according to claim 14 wherein a water supply orifice formed through the screw top cover (1b), a water supply cover threaded to the water supply orifice.

17. A portable pneumatic washing device (10) according to claim 15 wherein a water supply orifice formed through the screw top cover (1b), a water supply cover threaded to the water supply orifice.

18. A portable pneumatic washing device (10) according to claim 1 wherein the body (1) is a pipe with internal oval diameter, said first pipe (11) and push rod (6) are installed at one side of the pipe with internal oval diameter, said water supply orifice (16) and water supply cover (5) are installed at the other side of the oval shaped pipe.

19. A portable pneumatic washing device (10) according to claim 18 wherein the water supply orifice (16) is formed at a distal end of the body (1), the water supply cover (5) is threaded to the water supply orifice (16).
